(19) United States
(12) Patent Application Publication
(10) Pub. No.: US 2024/0330950 A1
(43) Pub. Date: Oct. 3, 2024

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Teruyoshi FUJIWARA, Toyota-shi (JP); Iwao Nitta, Nagoya-shi (JP); Ryota Suzuki, Osaka (JP)

(73) Assignee: TOYOTA JIDOSHA KABUSHIKI KAISHA, Toyota-shi (JP)

(21) Appl. No.: 18/395,913

(22) Filed: Dec. 26, 2023

(30) Foreign Application Priority Data
Mar. 31, 2023 (JP) 2023-057858

(51) Int. Cl. G06Q 30/018

(52) U.S. Cl. CPC G06Q 30/018

(57) ABSTRACT

The control unit of the information processing device receives registration of carbon footprint information regarding the carbon footprint of transportation of products of each company included in the supply chain. Then, at a predetermined timing, the control unit of the information processing device calculates the estimated value of the carbon footprint of a company included in the supply chain that has not yet completed the registration of carbon footprint information based on reference values.

### CROSS-REFERENCE TO RELATED APPLICATION

This application claims priority to Japanese Patent Application No. 2023-057858 filed on Mar. 31, 2023 incorporated herein by reference in its entirety.

### BACKGROUND

### 1. Technical Field

The present disclosure relates to an information processing device and an information processing method.

### 2. Description of Related Art

Japanese Unexamined Patent Application Publication No. 2012-113512 (JP 2012-113512 A) discloses an environmental load data management device that manages environmental load information that is information that equipment gives to an environment. The environmental load data management device disclosed in JP 2012-113512 A receives, from the equipment, information about a plurality of products manufactured by the equipment, and environmental load information indicating energy information when processing is performed for the products. Then, the environmental load data management device determines the proportion at which the products contribute, among environmental load data generated by using the equipment based on the received information.

### SUMMARY

An object of the present disclosure is to ensure traceability of a carbon footprint even when registration of carbon footprint information regarding transportation is delayed.

An information processing device according to a first aspect of the present disclosure includes a control unit configured to execute:
receiving registration of carbon footprint information regarding a carbon footprint for transportation of a product of each company included in a supply chain; and
calculating, at a predetermined timing, an estimated value of a carbon footprint of a company for which the registration of the carbon footprint information has not been completed, among the companies included in the supply chain, based on a reference value stored in advance.

An information processing method according to a second aspect of the present disclosure is an information processing method executed by a computer, and includes:
receiving registration of carbon footprint information regarding a carbon footprint for transportation of a product of each company included in a supply chain; and
calculating, at a predetermined timing, an estimated value of a carbon footprint of a company for which the registration of the carbon footprint information has not been completed, among the companies included in the supply chain, based on a reference value stored in advance.

The present disclosure makes it possibles to ensure traceability of a carbon footprint even when registration of carbon footprint information regarding transportation is delayed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an information processing system;

FIG. 2 is a diagram illustrating an example of the relationship between products supplied by the supply chain;

FIG. 3 is a block diagram schematically showing an example of the functional configuration of a server;

FIG. 4 is a diagram showing an example of a table structure of product information held in the product information database;

FIG. 5 is a diagram showing an example of a table structure of reference value information held in the reference value information database; and

FIG. 6 is a flowchart of processing executed by the control unit of the server.

### Detailed Description of Embodiments

In order to ensure traceability of carbon footprints in the supply chain, it is necessary to collect carbon footprint information throughout the supply chain. On the other hand, calculating the carbon footprint of the transportation of a company's products in a supply chain is time-consuming as it requires input into many items. Furthermore, since multiple companies are involved in the supply chain, carbon footprint information related to product transportation may not be registered smoothly. For these reasons, if some companies are unable to obtain carbon footprint information related to the transportation of their products, it becomes impossible to calculate the carbon footprint in the supply chain. This may make it difficult to ensure traceability of carbon footprints in the supply chain. The information processing device according to the first aspect of the present disclosure solves such problems.

The control unit of the information processing device according to the first aspect of the present disclosure receives registration of carbon footprint information regarding carbon footprints related to transportation of products of each company included in the supply chain. Then, at a predetermined timing, the control unit of the information processing device calculates the estimated value of the carbon footprint of a company included in the supply chain that has not yet completed the registration of carbon footprint information. Calculated based on reference values.

As explained above, at a predetermined timing, the information processing device calculates the estimated value of the carbon footprint of a company for which registration of carbon footprint information has not been completed based on the reference value. As a result, even if there is a company in the supply chain that has delayed registration of carbon footprint information, it is possible to calculate the carbon footprint related to transportation by that company using the carbon footprint estimate for that company. can. As a result, traceability of carbon footprint in the supply chain can be ensured.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### System Overview

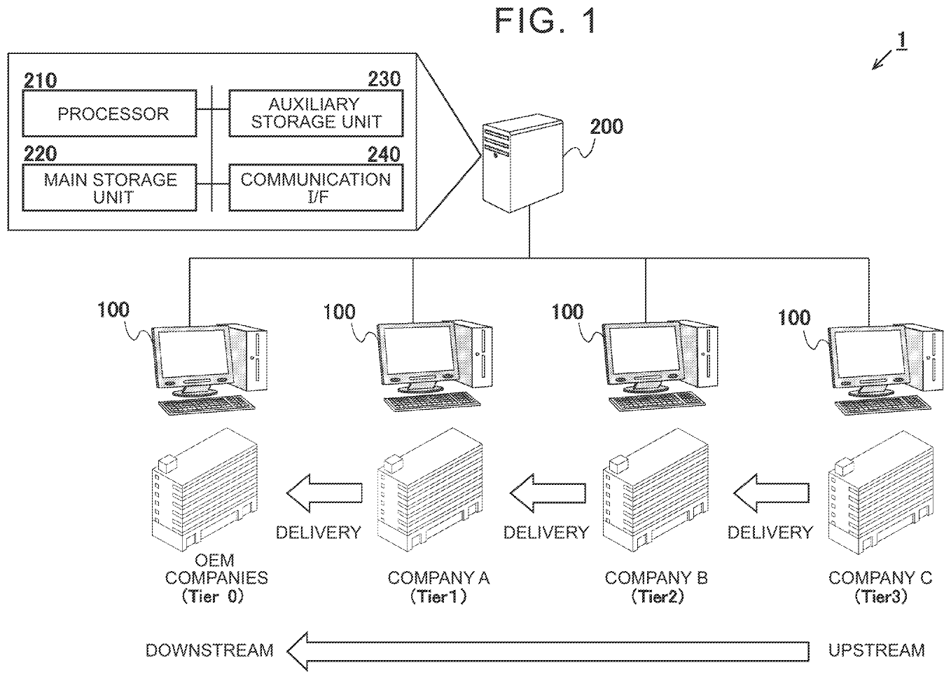

An information processing system 1 in the present disclosure will be described based on FIG. 1. FIG. 1 is a diagram schematically illustrating a configuration of an information processing system 1. The information processing system 1 includes a plurality of company terminals 100 and a server 200. In the information processing system 1, a company terminal 100 and a server 200 are interconnected via a network. For example, a Wide Area Network (WAN), which is a world-wide public communication network such as the Internet, may be adopted as the network.

First, we will explain the structure of the supply chain. The supply chain in this embodiment includes an OEM company and a plurality of companies that are suppliers. OEM companies are companies that assemble final products. Further, the plurality of companies (companies A, B, and C) that are suppliers are companies that supply parts, materials, assemblies, etc. for manufacturing the final product. A plurality of companies that are suppliers each produce a plurality of products and deliver the products to a company located one level below. Multiple companies repeat this process, and the final product is assembled in the final process.

Note that in this embodiment, the final product X is a battery. The final product X is, for example, a battery mounted on a vehicle. A battery mounted on a vehicle is a battery that supplies electricity to a motor that drives the vehicle. Further, the battery mounted on the vehicle may be a battery used as an auxiliary battery. Further, the final product X may be, for example, a stationary storage battery.

In this embodiment, the side that delivers products in a certain hierarchy is called the upstream side, and the side that purchases the products and produces new products is called the downstream side. In this specification, companies located on the upstream side are referred to as upstream companies, and companies located on the downstream side are referred to as downstream companies. Furthermore, products produced by upstream companies are referred to as upstream products, and products produced by downstream companies are referred to as downstream products. Downstream products include upstream products.

Furthermore, in this specification, a hierarchy included in a supply chain is referred to as a tier. Tier 0 is the lowest layer (corresponding to OEM companies) that assembles the final product, and as you progress through Tiers 1, 2, and 3, you move upstream. Depending on the layer of focus, downstream companies may become upstream companies. For example, company B located in Tier 2 is a downstream company in relation to Tier 3, but is an upstream company in relation to Tier 1. In this way, the definitions of upstream and downstream companies can change depending on the hierarchy.

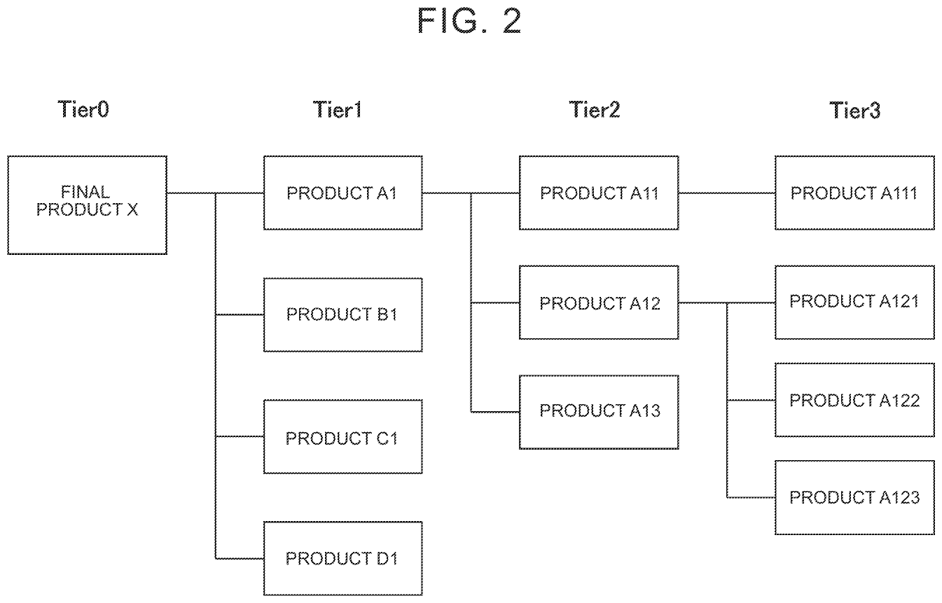

FIG. 2 is a diagram illustrating an example of the relationship between products supplied by the supply chain. In FIG. 2, the supply relationship of a plurality of products constituting the final product X is shown by a tree diagram. In the example shown in FIG. 2, final product X is produced by assembling products A1, B1, C1, and D1. Further, product A1 is produced by assembling products A11, A12, and A13. In this way, the relationships among the multiple products that make up the final product X can be represented by a tree diagram in which each product is a node.

In the example shown in FIG. 2, company A located in Tier 1 produces products A1, B1, C1, and D1 and delivers them to an OEM company located in Tier 0. Further, in the example shown in FIG. 2, company B located in Tier 2 produces products A11, A12, and A13 and delivers them to company A located in Tier 1. Further, in the example shown in FIG. 2, company C located in Tier 3 produces products A111, A121, A122, and A123, and delivers them to company B located in Tier 2. Note that a plurality of 20 companies may be located in each tier, and products produced by each company may be delivered to an upstream company (a company in one tier smaller).

Here, when company A delivers products A1, B1, C1, and D1 to an OEM company, transportation is performed from a factory of company A to a factory of the OEM company. Further, when company B delivers products A11, A12, and A13 to company A, the products are transported from company B's factory, etc. to company A's factory, etc. Furthermore, when company C delivers products A111, A121, A122, and A123 to company B, the products are transported from company C's factory, etc. to company B's factory, etc. In this way, the products produced by each company are transported in the supply chain. At this time, greenhouse gases are emitted when each company transports its products, corporate terminal

The company terminal 100 accepts input of information about a company's products (hereinafter sometimes referred to as “product information”). Product information is information indicating the delivery status of a company's products. The company terminal 100 receives input of information including, as product information, an identifier (delivery company ID) for identifying the company to which the company's products are delivered (delivery destination company), and an identifier (product ID) for identifying the product to be delivered to the destination company.

In addition, the company terminal 100 inputs, as product information, information on fuel consumption, loading rate, and emission intensity when the company transports the product (hereinafter sometimes referred to as “CFP information”). accept. The information indicating fuel consumption, loading rate, and emission intensity included in the CFP information is information indicating fuel consumption, loading rate, and emission intensity in a predetermined period. Note that the product information may be information in which part or all of the information indicating fuel consumption, loading rate, and emission intensity included in the CFP information is not input. The company terminal 100 transmits product information including CFP information to the server 200 via the network. In this way, each company registers product information and CFP information in the server 200.

### Server

The server 200 is a server that manages product supply relationships in the supply chain. Server 200 receives product information from each company. Based on the product information received from each company, the server 200 grasps the supply relationship of a plurality of products that make up the final product X shown in FIG. 2. The server 200 also monitors the carbon footprint of the transportation of products by each company based on the product information received from each company.

The server 200 requests each company to send product information (CFP information) in order to ensure traceability of carbon footprints in the supply chain. Information requesting each company to send product information (CFP information) is sent to the company terminal 100 of each company via the network. The information requesting each company to send product information (CFP information) includes a deadline for sending product information.

Based on the received product information (CFP information), the server 200 calculates the carbon footprint (hereinafter sometimes simply referred to as “carbon footprint”) of the transportation of the product in the supply chain. Here, in order for the server 200 to manage greenhouse gas emissions related to product transportation in the supply chain, it is necessary to collect CFP information of multiple companies included in the supply chain.

On the other hand, in order to create CFP information, many items are required to be entered into the company terminal 100, which is time-consuming. Furthermore, since multiple companies are involved in the supply chain, CFP information may not be registered smoothly. In this case, if CFP information is delayed for some companies, the server 200 will not be able to calculate the carbon footprint in the supply chain. This may make it difficult to ensure traceability of carbon footprints in the supply chain.

Therefore, the server 200 calculates an estimated value of the carbon footprint of a company included in the supply chain for which registration of CFP information has not been completed based on a reference value stored in advance. The details of how the server 200 calculates the carbon footprint estimate will be described later.

The server 200 includes a computer having a processor 210, a main storage unit 220, an auxiliary storage unit 230, and a communication interface (communication I/F) 240. Processor 210 is, for example, a Central Processing Unit (CPU) or a Digital Signal Processor (DSP). The main storage unit 220 is, for example, Random Access Memory (RAM). The auxiliary storage unit 230 is, for example, a Read Only Memory (ROM). Further, the auxiliary storage unit 230 is, for example, a Hard Disk Drive (HDD), or a disc recording medium such as a CD-ROM, a DVD disc, or a Blu-ray disc. The auxiliary storage unit 230 may be a removable medium (a portable storage medium). Examples of the removable medium include a USB memory or an SD card. The communication I/F 240 is, for example, a Local Area Network (LAN) interface board or a wireless communication circuit for wireless communication.

In the server 200, the auxiliary storage unit 230 stores an operating system (OS), various programs, various information tables, and the like. Further, in the server 200, the processor 210 loads a program stored in the auxiliary storage unit 230 into the main storage unit 220 and executes it, thereby realizing various functions as described below. However, some or all of the functions in the server 200 may be realized by a hardware circuit such as an ASIC or an FPGA. Note that the server 200 does not necessarily need to be realized by a single physical configuration, and may be configured by a plurality of computers that cooperate with each other.

### Functional Configuration

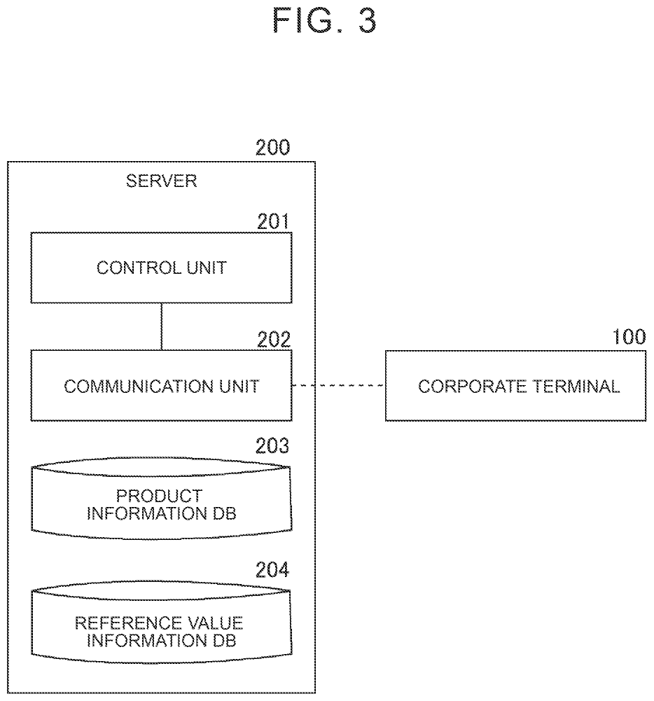

Next, the functional configuration of the server 200 that constitutes the information processing system 1 will be described based on FIGS. 3 to 5. FIG. 3 is a block diagram schematically showing an example of the functional configuration of the server 200. The server 200 includes a control unit 201, a communication unit 202, a product information database 203 (product information DB 203), and a reference value information database 204 (reference value information DB 204).

The control unit 201 has a function of performing arithmetic processing to control the server 200. The control unit 201 can be implemented by the processor 210 in the server 200. The communication unit 202 has a function of connecting the server 200 to the network N1. The communication unit 202 can be realized by the communication I/F 240 in the server 200.

The control unit 201 uses the communication unit 202 to receive product information from the company terminals 100 associated with each company. The control unit 201 stores the product information received from the company terminal 100 in the product information DB 203. The product information DB 203 has a function of holding product information received from each company terminal 100. The product information DB 203 can be realized by the auxiliary storage unit 230 in the server 200.

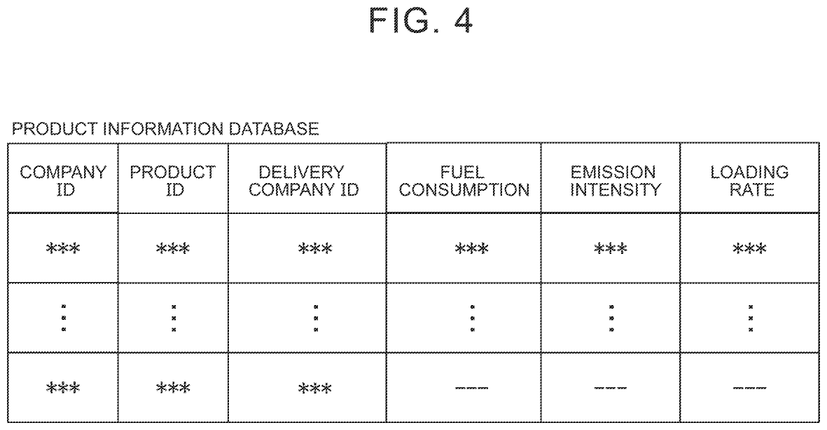

FIG. 4 is a diagram showing an example of a table structure of product information held in the product information DB 203. As shown in FIG. 4, the product information held in the product information DB 203 includes a company ID field, a product ID field, a delivery company ID field, a fuel usage amount field, an emission unit field, and a loading rate field.

The company ID field stores an identifier (company ID) for identifying the company that sent the product information. The product ID field stores a product ID for identifying the product of the company corresponding to the company ID stored in the company ID field. The delivery destination company ID field stores the company ID (delivery destination company ID) of the delivery destination company of the product corresponding to the product ID stored in the product ID field.

The fuel usage amount field stores information indicating the amount of fuel used by a delivery vehicle or the like when transporting the product to the destination company. The emission intensity field stores information indicating the amount of greenhouse gas emissions per amount of activity. Emission intensity is the amount of greenhouse gases emitted when a unit amount of fuel is used. The loading rate field stores information indicating the loading rate when the product is transported to the destination company. Here, the fuel usage field, emission intensity field, and loading rate field contain information indicating the fuel usage, emission intensity, and loading rate when the company actually transported the product during the specified period. Stored.

Further, there are cases where a company does not register all or part of its CFP information. In other words, a company may not have registered at least one of information on fuel consumption, loading ratio, and emission intensity. That is, the CFP information included in the product information may not include some information (information indicating at least one of fuel consumption, loading rate, and emission intensity). In this case, “---” is input into the field corresponding to the item whose information is not included in the CFP information among the fuel usage field, loading rate field, and emission unit field.

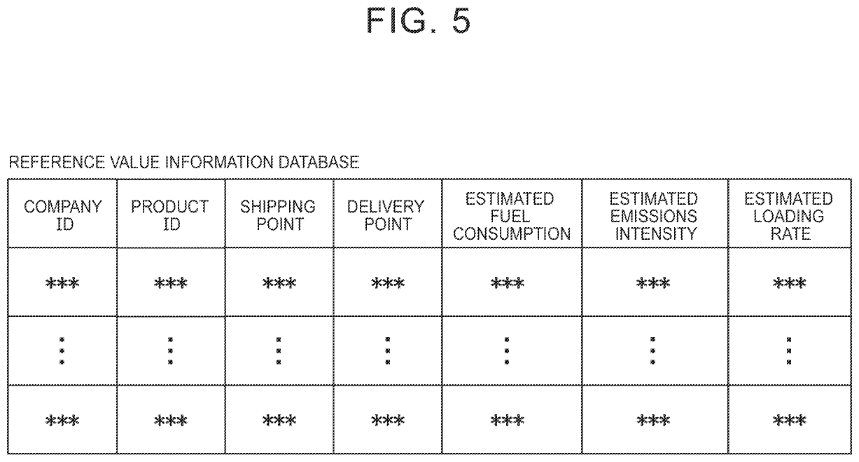

The reference value information DB 204 has a function of holding reference value information. The reference value information is information about reference values for calculating the estimated value of the carbon footprint. The reference value information DB 204 can be realized by the auxiliary storage unit 230 in the server 200. FIG. 5 is a diagram showing an example of a table configuration of reference value information held in the reference value information DB 204. As shown in FIG. 5, the reference value information includes a company ID field, a shipping point field, a delivery point field, an estimated fuel consumption field, an estimated emission unit field, and an estimated loading rate field.

The company ID field stores the company ID of each company included in the supply chain. The product ID field stores the product ID of the product of the company corresponding to the company ID stored in the company ID field. The shipping point field stores information indicating the shipping point (shipping point) of the product stored in the product ID field. Here, the shipping point field stores information indicating a predetermined location of a factory or the like where the product is produced, as the shipping point. The delivery point field stores information indicating the point where the product stored in the product ID field is delivered (delivery point). Here, the delivery point field stores information indicating a prearranged point, such as a factory of the destination company, to which the product is delivered, as the delivery point. Information indicating the shipping point and delivery point is registered in advance by the company that delivers the product.

The estimated fuel efficiency field stores information indicating the estimated fuel efficiency that is estimated to be used by the company corresponding to the company ID stored in the company ID field to transport the product. Here, fuel efficiency means the distance traveled by a transport vehicle or the like per unit of fuel. The estimated fuel efficiency field stores information indicating a predetermined fuel efficiency as the estimated fuel efficiency. The estimated fuel efficiency is, for example, the average value of fuel efficiency when products are transported by multiple companies included in the supply chain. Furthermore, the estimated fuel efficiency may be an average value calculated from the mileage and fuel consumption when the relevant company transported products in the past. Further, the estimated fuel consumption may be fuel consumption determined by laws, regulations, or the like, or by the administrator of the server 200 or the like.

The estimated emission unit field stores information indicating the estimated emission unit when the company corresponding to the company ID stored in the company ID field transports the product. Here, information indicating a predetermined emission intensity as an estimated emission intensity is stored in the estimated emission intensity field. The estimated emission intensity is, for example, the average value of the emission intensity calculated from the amount of fuel used and the amount of greenhouse gas emissions when multiple companies included in the supply chain transport products. Furthermore, the estimated emission intensity may be an average value of emission intensity calculated from the amount of fuel used and the amount of greenhouse gas emissions when the relevant company transported products in the past. Furthermore, the estimated emission intensity may be an emission intensity determined by laws, regulations, or the like, or by the administrator of the server 200 or the like.

The estimated loading rate field stores information indicating the estimated loading rate when the company corresponding to the company ID stored in the company ID field transports the product. Here, the estimated loading rate field stores information indicating a predetermined loading rate as the estimated loading rate. The estimated loading rate is, for example, the average value of the loading rates of transportation vehicles, etc. when multiple companies included in the supply chain transport products. Furthermore, the estimated loading rate may be an average value of loading rates when the relevant company has transported products in the past. Further, the estimated loading rate may be a loading rate determined by laws, regulations, or the like, or by the administrator of the server 200.

In order to ensure traceability of carbon footprints in the supply chain, the control unit 201 calculates carbon footprints related to transportation of a plurality of companies included in the supply chain at a predetermined timing. The timing (predetermined timing) at which the carbon footprint calculation in the supply chain is performed is, for example, a timing predetermined by the administrator of the server 200. Further, the timing at which the carbon footprint calculation in the supply chain is performed may be, for example, a legally stipulated timing. The control unit 201 refers to the product information held in the product information DB 203 and multiplies the fuel consumption, emission intensity, and loading rate for each product of each company. Calculate the carbon footprint (greenhouse gas emissions) of

On the other hand, among the companies included in the supply chain, there may be companies for which registration of some or all of the CFP information has not been completed. In this case, “---” is entered in at least one of the fuel consumption field, emission unit field, and loading ratio field in the product information held in the product information DB 203. Therefore, the control unit 201 refers to the fuel consumption field, the emission intensity field, and the loading rate field in the product information held in the product information DB 203, and determines whether part or all of the CFP information has been registered. Identify companies that do not.

The control unit 201 refers to the reference value information held in the reference value information DB 204 and acquires at least one of the shipping point, delivery point, and estimated fuel efficiency for the specified company (hereinafter sometimes referred to as “specific company”), and estimated emission intensity, and estimated loading rate.

Here, assume that the CFP information for a specific company does not include information indicating fuel consumption. In this case, the control unit 201 acquires information indicating the shipping point, delivery point, and estimated fuel consumption from the reference value information held in the reference value information DB 204 in order to calculate the estimated value of fuel consumption. do. Then, the control unit 201 searches for a transportation route through which the specific company is estimated to transport the product based on the shipping point and the delivery point. Then, the control unit 201 calculates an estimated value of fuel consumption by dividing the travel distance on the transportation route by the estimated fuel consumption.

Further, assume that the CFP information for a specific company does not include information indicating the emission intensity. In this case, the control unit 201 obtains the estimated emission intensity from the reference value information held in the reference value information DB 204 as the estimated value of the emission intensity. Further, assume that the CFP information for a specific company does not include information indicating the loading rate. In this case, the control unit 201 obtains the estimated loading rate from the reference value information held in the reference value information DB 204 as the estimated value of the loading rate.

Then, the control unit 201 uses the estimated value to calculate the carbon footprint of the specific company. If the CFP information about the specific company does not include information indicating the amount of fuel used, the control unit 201 multiplies the estimated value of the amount of fuel used by the emission unit and loading rate in the product information. In this way, the control unit 201 calculates the estimated value of the carbon footprint for the specific company.

Further, if the CFP information about the specific company does not include information indicating the emission intensity, the control unit 201 multiplies the estimated value of the emission intensity by the fuel consumption and loading rate in the product information. In this way, the control unit 201 calculates the estimated value of the carbon footprint for the specific company.

Further, if the CFP information about the specific company does not include information indicating the loading rate, the control unit 201 multiplies the estimated value of the loading rate by the fuel usage amount and emission unit in the product information. In this way, the control unit 201 calculates the estimated value of the carbon footprint for the specific company.

In addition, if two or more of the following items are not included in the CFP information for a specific company: fuel consumption, emissions intensity, and loading ratio, estimated values for these items will be used to calculate the estimated value of the carbon footprint of the specific company.

Note that information regarding a plurality of means of transportation may be stored in the estimated fuel efficiency field, estimated emission unit field, and estimated loading rate field in the reference value information. In the reference value information, the estimated fuel consumption field, estimated emission intensity field, and estimated loading rate field store information indicating estimated fuel efficiency, estimated emission intensity, and estimated loading rate, which differ for each means of transportation. It's okay. In this case, the transportation route search result may be a route that combines multiple transportation means. At this time, the control unit 201 calculates the estimated value of the carbon footprint by combining information stored in the estimated fuel consumption field, estimated emission unit field, and estimated loading rate field for each means of transportation. Additionally, if the transport route uses a terminal (station, port, airport, etc.), the amount of greenhouse gases emitted when transshipping the product at the terminal may be added to the estimate. The amount of greenhouse gases emitted during transshipment of products at the terminal is stored in the reference value information in the reference value information DB 204. Furthermore, the amount of greenhouse gases emitted when products are transshipped at a terminal may be set to different values depending on attributes such as the type or scale of the terminal.

### Flowchart

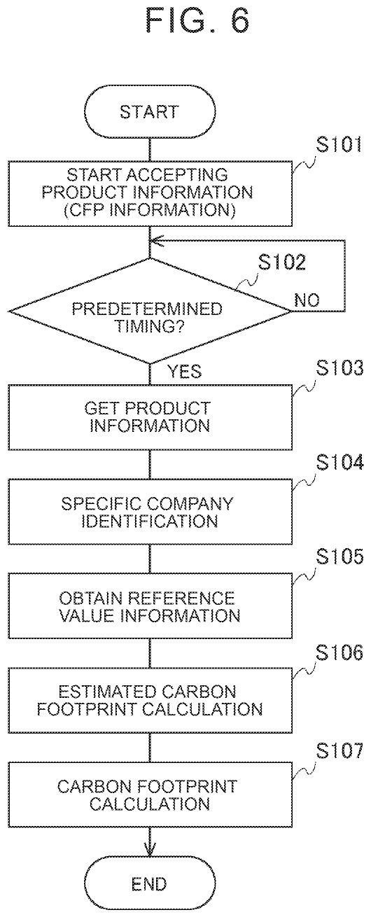

Next, processing executed by the control unit 201 of the server 200 in the information processing system 1 will be described based on FIG. 6. FIG. 6 is a flowchart of processing executed by the control unit 201 of the server 200. The process shown in FIG. 6 is a process for calculating the carbon footprint in the supply chain. The process shown in FIG. 6 starts when the server 200 sends information requesting the company terminal 100 associated with each company to send product information (CFP information).

In the process shown in FIG. 6, first, in S101, acceptance of registration of product information (CFP information) is started. Next, in S102, it is determined whether a predetermined timing has arrived. If the predetermined timing has not arrived, it is not the time to calculate the carbon footprint in the supply chain, and the process of S102 is executed again.

If an affirmative determination is made in S102, the control unit 201 acquires product information about each company from the product information DB 203 in S103. Next, in S104, the control unit 201 refers to the product information about each company acquired from the product information DB 203, and identifies a specific company. Next, in S105, reference value information about the specific company is acquired from the reference value information DB 204. Next, in S106, an estimated value of the carbon footprint for the specific company is calculated based on the reference value information for the specific company. Here, if there are multiple specific companies, the control unit 201 executes the processes of S105 and S106 for each specific company.

Next, in S107, the carbon footprint of the entire supply chain is calculated by combining the carbon footprints of companies other than the specific company and the estimated carbon footprint of the specific company. Here, the carbon footprint of companies other than the specific company is calculated based on product information held in the product information DB 203. Then, the process shown in FIG. 6 is ended.

The information processing device calculates an estimated value of the carbon footprint of a specific company based on the reference value at a predetermined timing. As a result, even if there is a company (specific company) in the supply chain that has delayed registration of carbon footprint information, traceability of carbon footprint can be ensured using the estimated value of the carbon footprint of the specific company.

### First Modification

In this embodiment, the predetermined timing is the time when the carbon footprint in the supply chain is calculated. However, the predetermined timing does not necessarily have to be the time when the carbon footprint calculation in the supply chain is performed. The predetermined timing may be, for example, the timing at which product information (CFP information) is received. That is, the server 200 calculates the estimated value of the carbon footprint based on the reference value information if registration of some or all of the CFP information is not completed at the timing of receiving the product information. Then, when the time for calculating the carbon footprint in the supply chain arrives, the calculated carbon footprint estimate is used to calculate the carbon footprint in the supply chain. In this way, even if there is a company in the supply chain that has delayed registration of carbon footprint information, it is possible to ensure traceability of the carbon footprint using the carbon footprint estimate for that company.

### Second Modification

In this embodiment, the product information includes CFP information. However, product information does not necessarily have to include CFP information. That is, the server 200 may receive CFP information separately from product information. In this case, when the server 200 receives the product information and has not received the CFP information, the server 200 may calculate an estimated value of the carbon footprint for the company that sent the product information. In this modification, the predetermined timing is the timing at which the server 200 receives product information. If the server 200 receives the CFP information after calculating the estimated value of the carbon footprint, it calculates the carbon footprint based on the CFP information. In other words, the server 200 can provisionally use the carbon footprint estimate until it receives the CFP information. In this way, even if a specific company exists, traceability of the carbon footprint can be ensured using the estimated value of the carbon footprint for the specific company.

### Modification Example 3

In this embodiment, the server 200 calculates the estimated value of the carbon footprint of the specific company based on at least one of the estimated values of fuel consumption, emission intensity, and loading ratio. However, if the product information about a specific company does not include at least one of the estimated values of fuel consumption, emission intensity, and loading rate, the server 200 uses the fixed value to estimate the carbon footprint of the specific company. It may be calculated as a value. Here, the fixed value is, for example, a legal fixed value. Furthermore, the fixed value may be a value determined by the administrator of the server 200 or the like.

### Modification Example 4

In this embodiment, the server 200 calculates the carbon footprint of the transportation of products by a plurality of companies included in the supply chain, as the carbon footprint of the entire supply chain. However, the server 200 may calculate the carbon footprint of the production and transportation of products in the supply chain, as the carbon footprint of the entire supply chain. In this case, the product information includes information indicating the amount of greenhouse gas emissions during production of the product. Then, the server 200 calculates the carbon footprint of the entire supply chain, which is the sum of greenhouse gases emitted during product production and greenhouse gases emitted during product transportation. Thereby, even if a specific company exists, it is possible to ensure traceability of the carbon footprint related to the manufacturing and transportation of the product using the estimated value of the carbon footprint related to the transportation of the product by the specific company.

### OTHER EMBODIMENTS

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk (such as a magnetic disk (a floppy disk an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device comprising a control unit configured to execute:
receiving registration of carbon footprint information regarding a carbon footprint for transportation of a product of each company included in a supply chain; and
calculating, at a predetermined timing, an estimated value of a carbon footprint of a company for which the registration of the carbon footprint information has not been completed, among the companies included in the supply chain, based on a reference value stored in advance.

2. The information processing device according to claim 1, wherein the predetermined timing is a timing at which the control unit receives, from the companies included in the supply chain, product information about a product of each of the companies.

3. The information processing device according to claim 1, wherein the predetermined timing is a timing at which the carbon footprint of an entirety of the supply chain is calculated.

4. The information processing device according to claim 1, wherein the carbon footprint information is information including fuel consumption, a loading rate, and an emission intensity when each of the companies transports the product.

5. An information processing method executed by a computer, the information processing method comprising:
receiving registration of carbon footprint information regarding a carbon footprint for transportation of a product of each company included in a supply chain; and
calculating, at a predetermined timing, an estimated value of a carbon footprint of a company for which the registration of the carbon footprint information has not been completed, among the companies included in the supply chain, based on a reference value stored in advance.
